(19) United States
(12) Patent Application Publication
(10) Pub. No.: US 2024/0030531 A1
(43) Pub. Date: Jan. 25, 2024

(54) BATTERY MODULE AND BATTERY PACK INCLUDING THE SAME

(71) Applicant: LG ENERGY SOLUTION, LTD., Seoul (KR)

(72) Inventors: Won Kyoung PARK, Daejeon (KR); Junyeob SEONG, Daejeon (KR); Sunghwan JANG, Daejeon (KR)

(73) Assignee: LG ENERGY SOLUTION, LTD., Seoul (KR)

(21) Appl. No.: 18/025,375

(22) PCT Filed: Apr. 14, 2022
(86) PCT No.: PCT/KR2022/005439

§ 371 Date: Mar. 8, 2023

(30) Foreign Application Priority Data
Jun. 23, 2021 (KR) 10-2021-0081819

(51) Int. Cl. H01M 50/211; H01M 50/507; H01M 10/658

(52) U.S. Cl. CPC H01M 50/211; H01M 50/507; H01M 10/658

(57) ABSTRACT

A battery module includes a battery cell stack in which a plurality of battery cells are stacked; a module frame that houses the battery cell stack; end plates that are located on one side and the other side of the battery cell stack and are formed with a terminal opening and a connector opening; a terminal busbar that is exposed through the terminal opening; and a module connector that is exposed through the connector opening, wherein the battery module further includes at least one of a terminal cover part that covers a portion where the terminal busbar is exposed, and a connector cover part that covers a portion where the module connector is exposed.

### TECHNICAL FIELD

### Cross Citation with Related Application(s)

This application claims the benefit of Korean Patent Application No. 10-2021-0081819 filed on Jun. 23, 2021 with the Korean Intellectual Property Office, the disclosure of which is incorporated herein by reference in its entirety.

The present disclosure relates to a battery module and a battery pack including the same, and more particularly to a battery module that can suppress the propagation of thermal runaway phenomenon and a battery pack including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, there is a growing need for development of the secondary battery.

Currently commercialized secondary batteries include a nickel cadmium battery, a nickel hydrogen battery, a nickel zinc battery, and a lithium secondary battery. Among them, the lithium secondary battery has come into the spotlight because they have advantages, for example, hardly exhibiting memory effects compared to nickel-based secondary batteries and thus being freely charged and discharged, and having very low self-discharge rate and high energy density.

Such lithium secondary battery mainly uses a lithium-based oxide and a carbonaceous material as a cathode active material and an anode active material, respectively. The lithium secondary battery includes an electrode assembly in which a cathode plate and an anode plate, each being coated with the cathode active material and the anode active material, are arranged with a separator being interposed between them, and a battery case which seals and houses the electrode assembly together with an electrolytic solution.

Generally, the lithium secondary battery may be classified based on the shape of the exterior material into a can-type secondary battery in which the electrode assembly is mounted in a metal can, and a pouch-type secondary battery in which the electrode assembly is mounted in a pouch of an aluminum laminate sheet.

In the case of a secondary battery used for small-sized devices, two to three battery cells are arranged, but in the case of a secondary battery used for a middle or large-sized device such as an automobile, a battery module in which a large number of battery cells are electrically connected is used. In such a battery module, a large number of battery cells are connected to each other in series or parallel to form a cell assembly, thereby improving capacity and output. Further, one or more battery modules can be mounted together with various control and protection systems such as a BMS (battery management system) and a cooling system to form a battery pack.

A battery pack in which a plurality of battery modules are assembled can add up the heat generated from the large number of battery cells in a narrow space, so that the temperature can rise more quickly and excessively. In other words, a battery module in which a large number of battery cells are stacked, and a battery pack equipped with such a battery module can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases.

Moreover, in the case of a battery module included in a vehicle battery pack, it is frequently exposed to direct sunlight and may be placed under high-temperature conditions such as summer or desert areas. Further, since a plurality of battery modules are concentratedly arranged to increase the mileage of the vehicle, a thermal runaway phenomenon generated in one battery module can easily propagate to an adjacent battery module, which may eventually lead to ignition or explosion of the battery pack itself.

Therefore, there is a need to design a model that does not lead to fire or explosion of the battery pack itself, even if a thermal runaway phenomenon occurs in any one of the battery cells

### DETAILED DESCRIPTION OF THE INVENTION

### Technical Problem

It is an object of the present disclosure to provide a battery module that can suppress the ejection of high-temperature gas and flame even if the thermal runaway phenomenon occurs in any one of the battery cells, and a device including the same.

However, the problem to be solved by the embodiments of the present disclosure is not limited to the above-described problems, and can be variously expanded within the scope of the technical idea included in the present disclosure.

### Technical Solution

According to one embodiment of the present disclosure, there is provided a battery module comprising: a battery cell stack in which a plurality of battery cells are stacked; a module frame that houses the battery cell stack; end plates that are located on a first side and a second side of the battery cell stack, each end plate having a terminal opening and a connector opening; a terminal busbar that is exposed through the terminal opening; and a module connector that is exposed through the connector opening, wherein the battery module further comprises a cover, the cover being at least one of a terminal cover part that covers a portion where the terminal busbar is exposed, and a connector cover part that covers a portion where the module connector is exposed.

The battery module may include an external busbar joined to the terminal busbar. The cover may be the terminal cover part, the terminal cover part may cover a portion where the terminal busbar and the external busbar are joined.

The terminal cover part may be formed with a terminal passing part through which the external busbar passes.

The battery module may further include a connection member connected to the module connector. The cover is the connector cover part, the connector cover part may cover a portion where the connection member and the module connector are connected.

The connector cover part may be formed with a connector passing part through which the connection member passes.

The battery module may further include a busbar frame located between the battery cell stack and the end plate.

The terminal busbar and the module connector may be mounted on the busbar frame.

The battery module may further include an insulating cover located between the busbar frame and the end plate.

The cover may be the terminal cover part, the terminal cover part may be fastened to the end plate or the insulating cover through a hinge.

A terminal opening hole may be formed in a portion of the insulating cover corresponding to the terminal opening.

The terminal cover part may cover the terminal opening hole.

A connector opening hole may be formed in a portion of the insulating cover corresponding to the connector opening.

The cover may be the connector cover part, and the connector cover part may cover the connector opening hole.

### Advantageous Effects

According to embodiments of the present disclosure, even if a thermal runaway phenomenon occurs in the battery module, the cover part closes the gap formed in the battery module, thereby capable of suppressing the ejection of high-temperature gas and flame to the outside.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a battery module according to an embodiment of the present disclosure;

FIG. 2 is an exploded perspective view which shows a battery cell stack, a busbar frame, and a module frame included in the battery module of FIG. 1;

FIG. 3 is a plan view of a battery cell included in the battery cell stack of FIG. 2;

FIG. 4 is a partial perspective view which enlarges and shows an end plate portion of the battery module of FIG. 1;

FIG. 5 is a partial perspective view which shows a state in which the end plate and the insulating cover are removed from the battery module of FIG. 4;

FIGS. 6(a) and (b) are diagrams which show a terminal busbar according to an embodiment of the present disclosure.

FIG. 7 is a partial perspective view which shows a sensing assembly according to an embodiment of the present disclosure;

FIG. 8 is a partial perspective view which shows a configuration in which an external busbar is connected to a battery module according to an embodiment of the present disclosure;

FIG. 9 is a partial perspective view which shows a state in which the terminal cover of FIG. 8 is opened;

FIG. 10 is a cross-sectional view which shows a cross-section taken along the cutting line A-A′ of FIG. 8;

FIG. 11 is a partial perspective view which enlarges and shows a connector cover according to an embodiment of the present disclosure; and

FIG. 12 is a cross-sectional view which shows a cross section taken along the cutting line B-B′ of FIG. 11.

### DETAILED DESCRIPTION OF THE EMBODIMENTS

Hereinafter, various embodiments of the present disclosure will be described in detail with reference to the accompanying drawings so that those skilled in the art can easily carry out them.

The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means arranged on or below a reference portion, and does not necessarily mean being arranged on the upper end of the reference portion toward the opposite direction of gravity.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

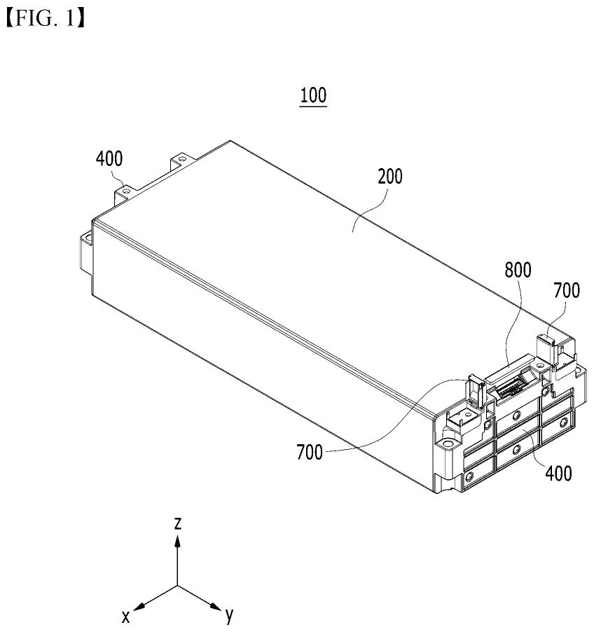

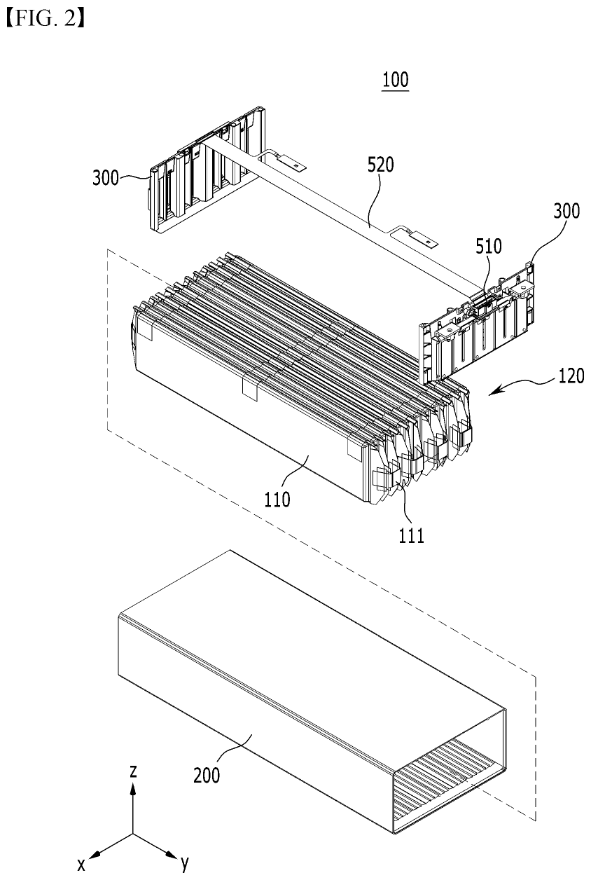

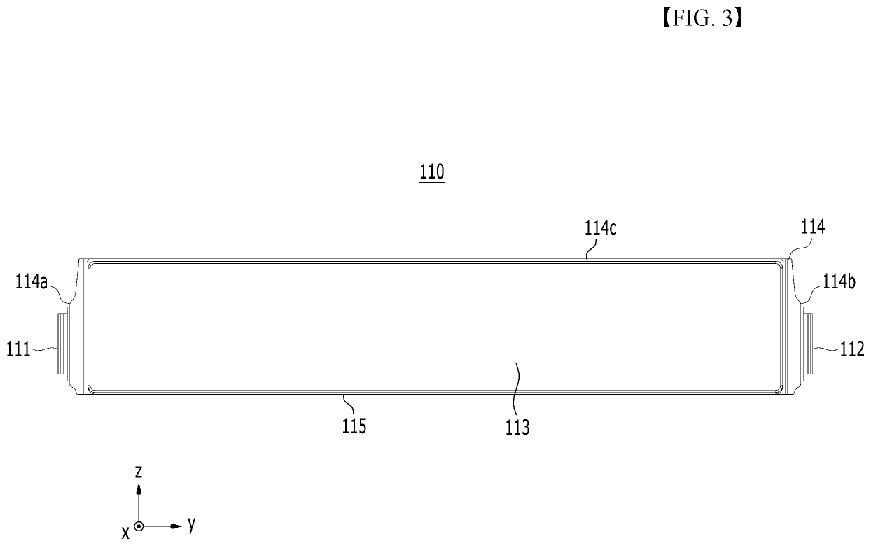

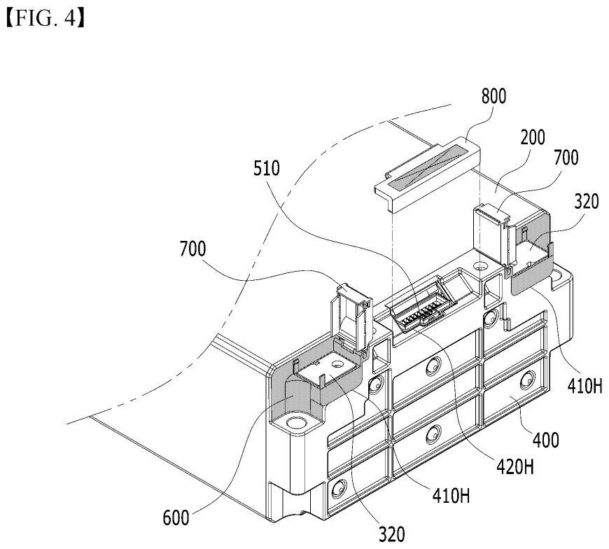

FIG. 1 is a perspective view of a battery module according to an embodiment of the present disclosure. FIG. 2 is an exploded perspective view which shows a battery cell stack, a busbar frame, and a module frame included in the battery module of FIG. 1. FIG. 3 is a plan view of a battery cell included in the battery cell stack of FIG. 2. FIG. 4 is a partial perspective view which enlarges and shows an end plate portion of the battery module of FIG. 1. At this time, FIG. 2 is an exploded perspective view which shows a state in which the end plate 400 and the insulating cover 600 are removed from the battery module 100 shown in FIGS. 1 and 4.

Referring to FIGS. 1 to 4, a battery module 100 according to an embodiment of the present disclosure includes a battery cell stack 120 in which a plurality of battery cells 110 are stacked; a module frame 200 that houses the battery cell stack 120; end plate 400 that are located on one side and the other side of the battery cell stack 120, and the like.

First, the battery cells 110 may be preferably pouch-type battery cells. The pouch-type battery cells can be manufactured by housing the electrode assembly in a pouch case of a laminated sheet including a resin layer and a metal layer, and then heat-sealing the outer peripheral part of the pouch case. At this time, the battery cell 110 may be formed in a rectangular sheet-like structure as shown in FIG. 3.

Specifically, the battery cell 110 according to the present embodiment may have a structure in which two electrode leads 111 and 112 face each other and protrude from one end 114a and the other end 114b of the battery body 113, respectively. The battery cell 110 can be manufactured by joining both ends 114a and 114b of a battery case 114 and one side part 114c connecting them in a state in which an electrode assembly (not shown) is housed in a battery case 114. In other words, the battery cells 110 according to an embodiment of the present embodiment have a total of three sealing parts, the sealing parts have a structure that is sealed by a method such as heat-sealing, and the remaining other one side part can be composed of a connection part 115. Between both end parts 114a and 114b of the battery case 114 can be defined as the longitudinal direction of the battery cell 110, and between one side part 114c connecting both end parts 114a and 114b of the battery case 114 and the connection part 115 can be defined as the width direction of the battery cell 110.

Meanwhile, only the battery cell 110 having a structure in which the electrode leads 111 and 112 protrude in both directions on one side and the other side has been described, but it goes without saying that in another embodiment of the present disclosure, a unidirectional pouch-type battery cell in which electrode leads protrude together in one direction is also possible.

The battery cell 110 may be configured in plural numbers, and the plurality of battery cells 110 may be stacked along one direction so as to be electrically connected to each other, thereby forming a battery cell stack 120. For example, as shown in FIG. 2, a plurality of battery cells 110 may be stacked along a direction parallel to the x-axis. The pouch-type battery case 114 is generally formed of a laminate structure of a resin layer/metallic thin film layer/resin layer. For example, a surface of the pouch-type battery case 114 formed of an O(oriented)-nylon layer tends to slide easily by an external impact when a plurality of battery cells 110 are stacked to form a medium or large-sized battery module. Therefore, in order to prevent this sliding and maintain a stable stacked structure of the battery cells, an adhesive member, for example, a sticky adhesive such as a double-sided tape or a chemical adhesive coupled by a chemical reaction upon adhesion can be attached to the surface of the battery case to form the battery cell stack 120.

The battery cell stack 120 is housed in the module frame 200. The module frame 200 may be a metal frame having a shape in which both surfaces are opened. More specifically, the module frame 200 may be opened in both directions in which the electrode leads 111 and 112 protrude with reference to the battery cell stack 120. However, the module frame 200 shown in FIG. 2 is an exemplary structure, and the shape thereof is not particularly limited as long as it can house the battery cell stack 120. The module frame 200 of FIG. 2 is shown as a mono frame in the form of a metal plate in which the upper surface, the lower surface and both side surfaces are integrated, but both a shape in which an upper cover is joined to a U-shaped frame with an open upper part, and a shape in which a U-shaped frame and an inverted U-shaped frame are coupled with each other, or the like, are possible.

End plates 400 are located on one side and the other side of the battery cell stack 120. That is, the end plates 400 may be located on the opened both surfaces of the module frame 200.

The module frame 200 and the end plate 400 can be joined by welding or the like in a state in which the corresponding corner portions are in contact with each other. However, this is an exemplary method, and bolt fastening, hook fastening, or the like can be applied as a mechanical coupling form. The battery cell stack 120 is housed in the space formed by the module frame 200 and the end plate 400, thereby capable of physically protecting the battery cell stack 120. For this purpose, the module frame 200 and the end plate 400 may include a metal material having a predetermined strength such as aluminum or a plastic material.

Meanwhile, the battery module 100 according to the present embodiment may include a busbar frame 300 located between the battery cell stack 120 and the end plate 400. Also, the battery module 100 may include an insulating cover 600 located between the busbar frame 300 and the end plate 400. That is, the busbar frame 300, the insulating cover 600, and the end plate 400 may be sequentially located from the battery cell stack 120 to the outside. Similarly to the end plate 400, the busbar frame 300 and the insulating cover 600 may each be configured in plural numbers.

Next, a busbar terminal and a terminal opening according to the present embodiment will be described in detail with reference to FIGS. 4 to 6, and the like.

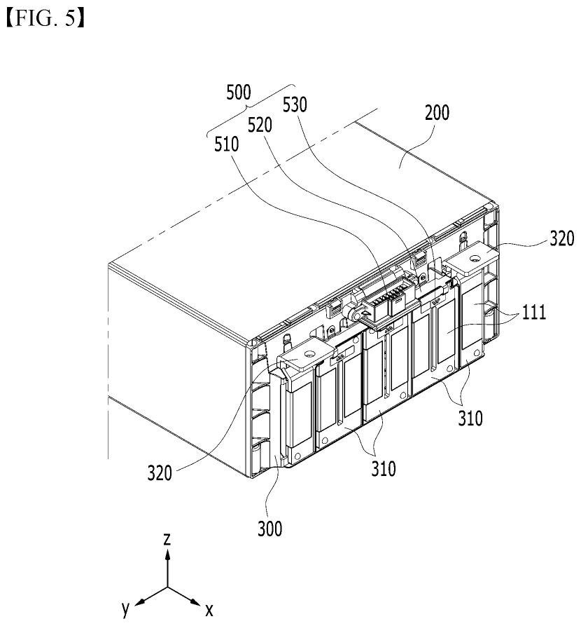

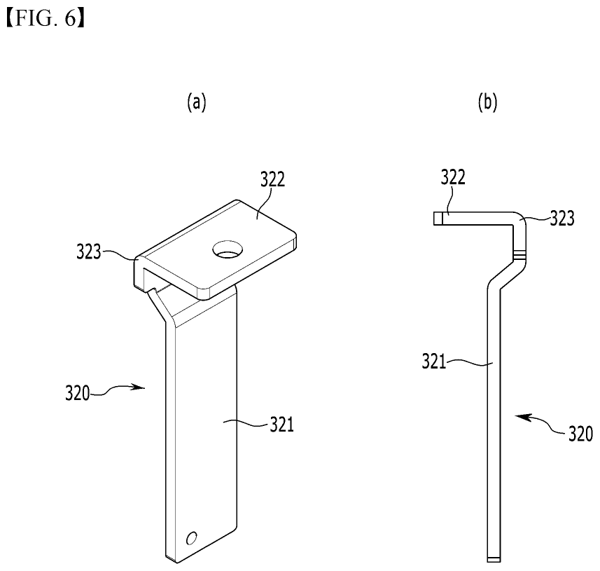

FIG. 5 is a partial perspective view which shows a state in which the end plate and the insulating cover are removed from the battery module of FIG. 4. FIGS. 6(a) and (b) are diagrams which show a terminal busbar according to an embodiment of the present disclosure.

Referring to FIGS. 2, FIG. 4 to FIG. 6 together, a terminal opening 410H is formed in the end plate 400 according to an embodiment of the present disclosure, and the battery module 100 includes a terminal busbar 320 exposed through the terminal opening 410H. In particular, the terminal busbar 320 may be mounted on the busbar frame 300.

More specifically, the battery module 100 according to the present embodiment may include a busbar 310 and a terminal busbar 320. The busbar 310 and the terminal busbar 320 may be mounted on the busbar frame 300.

The busbar 310 and the terminal busbar 320 can be joined to the electrode lead 111 of the battery cells 110 in order to electrically connect the plurality of battery cells 110. Specifically, the busbar frame 300 on which the busbar 310 and the terminal busbar 320 are mounted can be disposed on the one side (x-axis direction) and the other side (−x-axis direction) of the battery cell stack 120. The one side (x-axis direction) and the other side (−x-axis direction) of the battery cell stack 120 correspond to the direction in which the electrode leads 111 and 112 of the battery cells 110 protrude. That is, as described above, any one of the busbar frames 300 may be located between any one of the end plates 400 and the battery cell stack 120.

A lead slit may be formed at the busbar frame 300, and the electrode leads 111 and 112 of the battery cells 110 can be bent after passing through the lead slit, and joined to the busbar 310 or the terminal busbar 320. As long as physical and electrical connection is possible, the joining method is not particularly limited, and weld-joining can be performed as an example. That is, the battery cells 110 may be electrically connected to each other via the busbar 310.

Meanwhile, a part of the terminal busbar 320 may be exposed to the outside of the battery module 100. As described above, a terminal opening 410H is formed in the end plate 400, and a part of the terminal busbar 320 may be exposed through such terminal opening 410H. More specifically, the terminal busbar 310 includes a first portion 321 connected to the electrode lead 111 of the battery cells 110 and a second portion 322 exposed to the outside through the terminal opening 410H.

The second portion 322 exposed to the outside of the battery module 100 may be connected to another battery module or a BDU (Battery Disconnect Unit) to form a HV (High Voltage) connection. Here, the HV connection is a connection that functions as a power source for supplying power, and refers to a connection between battery cells or a connection between battery modules. That is, the battery module 100 can be electrically connected to other adjacent battery modules via the terminal busbar 320.

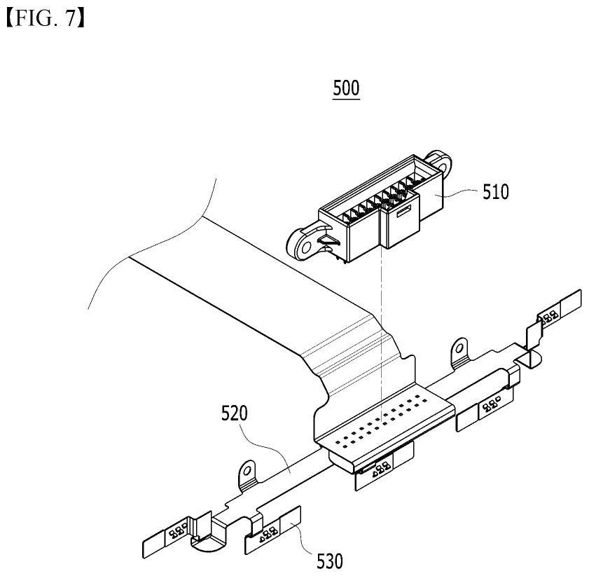

Next, a sensing assembly and a connector opening according to an embodiment of the present disclosure will be described in detail with reference to FIG. 4, FIG. 5 and FIG. 7, etc.

FIG. 7 is a partial perspective view which shows a sensing assembly according to an embodiment of the present disclosure.

Referring to FIG. 2, FIG. 4, FIG. 5 and FIG. 7 together, the end plate 400 according to an embodiment of the present disclosure is formed with a connector opening 420H, and the battery module 100 includes a module connector 510 exposed through the connector opening 420H.

Specifically, the battery module 100 according to the present embodiment may include a sensing assembly 500 for sensing connection of the battery module 100. Here, the sensing assembly 500 is for connecting LV (Low voltage), wherein the LV connection means a sensing connection for sensing and controlling the voltage and temperature of the battery cell. The voltage information and temperature information of the battery cell 110 can be measured through the sensing assembly 500 and transmitted to an external BMS (battery management system).

The sensing assembly 500 according to the present embodiment may include a module connector 510, a connection cable 520, and a joining member 530.

The module connector 510 is configured so as to transmit and receive signals to and from an external control device. A connector opening 420H is formed in the end plate 400, the module connector 510 is exposed to the outside of the battery module 100 through the connector opening 420H, and the module connector 510 may be connected to an external BMS. The module connector 510 may be mounted on the busbar frame 300.

The connection cable 520 is configured to connect the module connector 510 and the bonding member 530, and may be a flexible printed circuit board (FPCB) or a flexible flat cable (FFC). The module connector 510 and the connection cable 520 may be located on the busbar frame 300.

A joining member 530 may be connected to one end of the connection cable 520, and the joining member 530 may be joined to one surface of the busbar 310 by welding.

Voltage information on the plurality of battery cells 110 is transmitted to an external BMS (Battery Management System) through the busbar 310, the joining member 530, the connection cable 520, and the module connector 510 in sequence.

Meanwhile, as shown in FIG. 2, two busbar frames 300 may be arranged on one side and the other side of the battery cell stack 120, respectively. At this time, the module connector 510 is located only in one busbar frame 300, and a module connector may not be located in another busbar frame 300. A connection cable 520 can extend from the module connector 510 to the other busbar frame 300 so that the module connector 510 can be connected to the busbars 310 located in the other busbar frames 300. The extended portion of the connection cable 520 may be located on the battery cell stack 120. In addition, a temperature sensor may be provided on a portion of the connection cable 520 located on the upper portion of the battery cell stack 120. Through such a temperature sensor, temperature information inside the battery module 100 may be sequentially transmitted to an external BMS (Battery Management System) through a connection cable 520 and a module connector 510.

In the above manner, the sensing assembly 500 may detect and control phenomena such as overvoltage, overcurrent, and overheating of each battery cell 110.

Meanwhile, as described above, the battery module 100 according to the present embodiment may include an insulating cover 600 located between the busbar frame 300 and the end plate 400. The insulating cover 600 is preferably configured in plural numbers. The insulating cover 600 may include an electrically insulating material, and prevents the busbar 310 or the terminal busbar 320 from contacting the end plate 400.

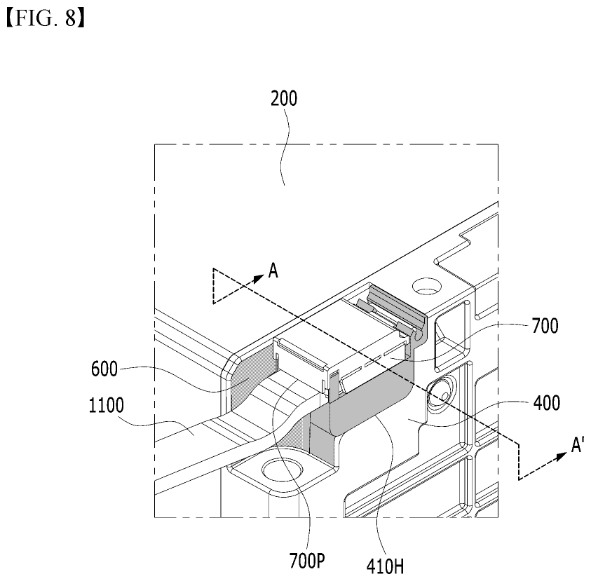

Next, the terminal cover part according to the present embodiment will be described in detail with reference to FIGS. 8 to 10 and the like.

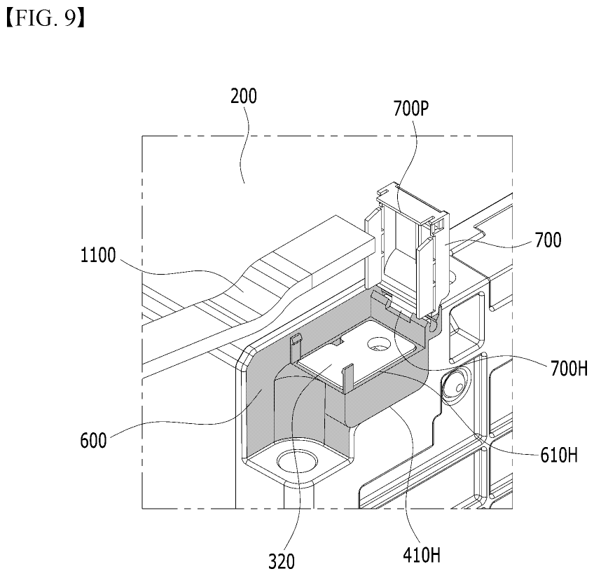

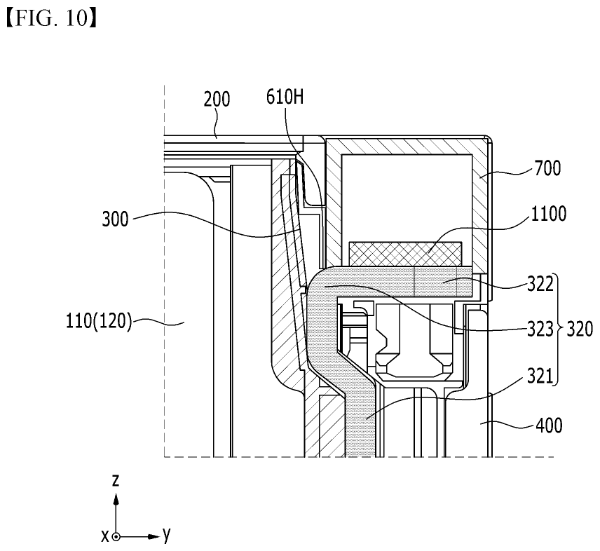

FIG. 8 is a partial perspective view which shows a configuration in which an external busbar is connected to a battery module according to an embodiment of the present disclosure. FIG. 9 is a partial perspective view which shows a state in which the terminal cover of FIG. 8 is opened. FIG. 10 is a cross-sectional view which shows a cross-section taken along the cutting line A-A′ of FIG. 8.

Referring to FIG. 1, FIG. 4, FIG. 5, FIG. 8 to FIG. 10 together, a terminal opening hole 610H may be formed in a portion of the insulating cover 600 corresponding to the terminal opening 410H of the end plate 400. The terminal busbar 320 according to the present embodiment may be exposed to the outside of the battery module 100 through the terminal opening hole 610H of the insulating cover 600 and the terminal opening 410H of the end plate 400.

Meanwhile, the terminal busbar 320 is configured in plural numbers, one of which may function as a cathode terminal of the battery module 100, and the other may function as an anode terminal of the battery module 100. Thereby, each of the terminal opening 410H and the terminal opening hole 610H may be configured in plural numbers.

The battery module 100 according to the present embodiment may include a terminal cover part 700 covering a portion where the terminal busbar 320 is exposed.

Specifically, as described above, the terminal busbar 320 is to be exposed to the outside of the battery module 100 through the terminal opening hole 610H of the insulating cover 600 and the terminal opening 410H of the end plate 400. In particular, the second portion 322 of the terminal busbar 320 may be exposed to the outside through the terminal opening hole 610H and the terminal opening 410H. At this time, the battery module 100 according to the present embodiment may further include an external busbar 1100 joined to the terminal busbar 320. The external busbar 1100 is a member for connecting the battery module 100 to another battery module or BDU, and may be connected to the second part 322 of the terminal busbar 320. As one example, the external busbar 1100 may be joined to the second part 322 of the terminal busbar 320 by welding.

The terminal cover part 700 according to the present embodiment may cover a portion where the terminal busbar 320 and the external busbar 1100 are joined. That is, the terminal cover part 700 may cover a portion where the second part 322 of the terminal busbar 320 and the external busbar 1100 are joined. At this time, the terminal cover part 700 may be formed with a terminal passing part 700P through which the external busbar 1100 passes. The terminal passing part 700P may have an open shape or a through hole shape. In one example, FIGS. 8 and 9 show that the external busbar 1100 can be inserted through the terminal passing part 700P having an open form. In summary, the terminal cover part 700 according to the present embodiment can guide the connection of the external busbar 1100 while closing the gap formed in the terminal opening hole 610H or the terminal opening 410H.

Meanwhile, as described above, the insulating cover 600 is located between the busbar frame 300 and the end plate 400 for electrical insulation. At this time, as shown in FIGS. 8 and 9, the terminal opening hole 610H may have an opening area smaller than that of the terminal opening 410H in order to ensure insulation, and the inner side of the terminal opening hole 610H may be located closer to the terminal busbar 320 than an inner side of the terminal opening 410H.

The terminal cover part 700 according to the present embodiment may have a form that covers the terminal opening hole 610H of the insulating cover 600. Further, the terminal cover part 700 may include a terminal hinge part 700H, and the terminal cover part 700 may be hinge-coupled to the insulating cover 600 by the terminal hinge part 700H. The terminal cover portion 700 can be opened and closed in accordance with such a hinge coupling structure. That is, the external busbar 1100 is joined to the second part 322 of the terminal busbar 320 in a state in which the terminal cover part 700 is opened, and then the terminal cover part 700 can close the gap formed by the terminal opening hole 610H.

Meanwhile, although not specifically shown in the figure, the terminal cover part according to another embodiment of the present disclosure may be fastened to the end plate through a hinge, and the terminal opening may be opened or closed by the terminal cover part in accordance with the hinge coupling structure.

A thermal runaway phenomenon may occur in the battery cells 110 inside the battery module 100. One example of a thermal runaway phenomenon is as follows. Physical, thermal, and electrical damage including overcharging may incur to the battery cell 110, thereby increasing the internal pressure of the battery cell 110. When the fusion strength limit value of the pouch-type cell case of the battery cell 110 is exceeded, high-temperature heat, venting gas, and the like generated in the battery cell 110 may be ejected to the outside of the battery cell 110.

The thermal runaway phenomenon occurring in one battery cell may spread to other battery cells due to a convection effect, and eventually, high-temperature gas and flame may be generated inside the battery module 100. The generated high-temperature gas and flame may be ejected to the outside through the terminal opening 410H of the end plate 400 or the terminal opening hole 610H of the insulating cover 600, which may damage the adjacent battery module or cause another thermal runaway phenomenon of the adjacent battery module. Ultimately, the thermal runaway phenomenon may propagate to a plurality of battery modules, which may cause explosion and ignition of the battery pack.

Thus, the terminal cover part 700 can be provided in the battery module 100 according to the present embodiment to thereby close the gap between the terminal opening hole 610H and the terminal busbar 320. Thereby, high-temperature gas or flame can be suppressed from being ejected to the outside of the battery module 100. Ultimately, it is possible to prevent the thermal runaway phenomenon occurring in one of the battery modules from propagating to other battery modules.

As described above, the terminal busbar 320 may include a first portion 321 connected to the electrode lead 111 of the battery cells 110, and a second portion 322 exposed to the outside through the terminal opening 410H. Further, the terminal busbar 320 may further include a bending part 323 formed between the first portion 321 and the second portion 322. Thereby, one surface of the first portion 321 and one surface of the second portion 322 may be perpendicular to each other. In other words, a bending part 323 is formed in the terminal busbar 320, and one surface of the second portion 322 is arranged parallel to the ground, which is thus designed to facilitate joining of the second portion 322 and the external busbar 1100.

In accordance with the structure as described above, a gap is naturally formed between the inner side of the terminal opening hole 610H and the bending part 323 or between the inner side of the terminal opening hole 610H and the second portion 322, and high-temperature gas and flame may be concentratedly ejected through the gap. In the present embodiment, since the terminal cover part 700 is arranged so as to block the gaps, it is possible to suppress the ejection of high-temperature gas or flame to the outside.

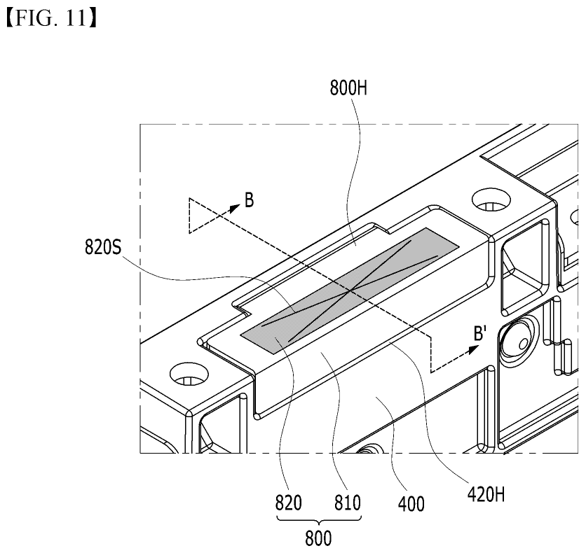

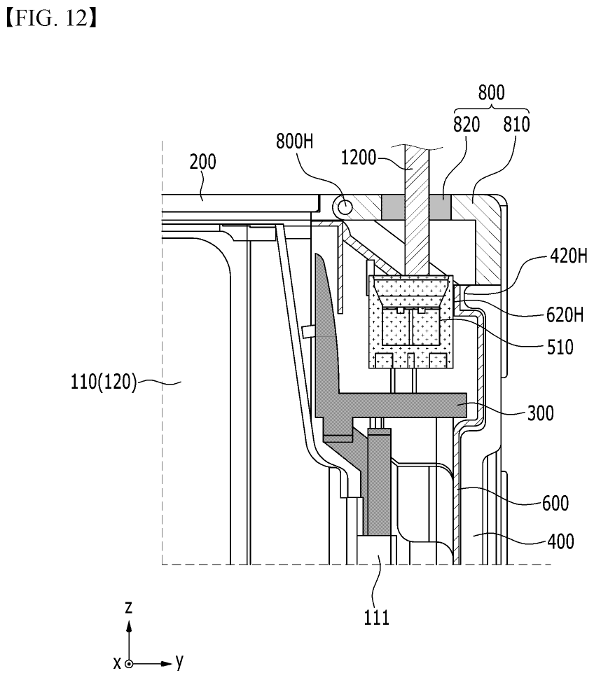

Hereinafter, a connector cover part according to an embodiment of the present disclosure will be described in detail with reference to FIGS. 11 and 12.

FIG. 11 is a partial perspective view which enlarges and shows a connector cover according to an embodiment of the present disclosure. FIG. 12 is a cross-sectional view which shows a cross section taken along the cutting line B-B′ of FIG. 11.

Referring to FIG. 1, FIG. 4, FIG. 5, FIG. 11 and FIG. 12 together, the battery module 100 according to the present embodiment may include a connector cover part 800 covering a portion where the module connector 510 is exposed.

At this time, the battery module 100 may include at least one of the terminal cover part 700 and the connector cover part 800. That is, the battery module according to an embodiment of the present disclosure may include any one of the terminal cover part 700 and the connector cover part 800, and the battery module according to another embodiment of the present disclosure may include both the terminal cover part 700 and the connector cover part 800.

Meanwhile, a connector opening hole 620H may be formed in a portion corresponding to the connector opening 420H of the end plate 400 in the insulating cover 600 according to the present embodiment. The module connector 510 may be exposed to the outside of the battery module 100 through the connector opening hole 620H of the insulating cover 600 and the connector opening 420H of the end plate 400.

The battery module 100 according to the present embodiment may further include a connection member 1200 connected to the module connector 510. The connection member 1200 (see FIG. 12) is a member for transmitting voltage information or temperature information of the battery module 100 to an external BMS, and may be connected to the module connector 510.

The connector cover part 800 according to the present embodiment can cover a portion where the connection member 1200 and the module connector 510 are connected. At this time, the connector cover part 800 may be formed with a connector passing part 820 through which the connection member 1200 passes. In one example, the connector cover part 800 according to the present embodiment may include a connector passing part 820 in which a body part 810 and a slit 820S are formed. The body part 810 may include a metal material similar to the end plate 400, and the connector passing part 820 may include a material that is electrically insulated and has flexibility. A slit 820S may be formed in the connector passing part 820, and the connection member 1200 may be connected to the module connector 510 through the slit 820S. That is, it is possible to cover a portion where the connection member 1200 and the module connector 510 are connected via the body part 810, and to guide the connection between the connection member 1200 and the module connector 510 via the connector passing portion 820.

However, the connector passing part 820 in which the slit 820S is formed is an example designed to allow the connection member 1200 to pass through, and it goes without saying that other forms such as through holes can be applied. In summary, the connector cover part 800 according to the present embodiment can guide the connection of the connection member 1200 while closing the gap formed in the connector opening hole 620H or the connector opening 420H.

Meanwhile, the connector cover part 800 may include a connector hinge part 800H. The connector cover part 800 may be hinge-coupled to the end plate 400 or the insulating cover 600 by the connector hinge part 800H. In accordance with this hinge coupling structure, the connector cover part 800 may be opened and closed. In one example, a connector hinge part 800H may be formed on one side of the body part 810.

Meanwhile, as shown in FIG. 12, the connector opening hole 620H may have an opening area smaller than that of the connector opening 420H in order to secure insulation, and the inner side of the connector opening hole 620H may be located closer to the module connector 510 than the inner side of the connector opening 420H. Further, the connector opening hole 620H may be opened upward.

The connector cover part 800 according to the present embodiment may have a form that covers the connector opening 420H and the connector opening hole 620H of the end plate 400. The connector cover part 800 covers the connector opening hole 620H and the connector opening 420H, and the connection member 1200 passing through the connector passing part 820 may be connected to the module connector 510 having a shape in which it is inserted into the module connector 510.

As described above, a high-temperature gas and flame may be generated due to a thermal runaway phenomenon inside the battery module 100. The generated high-temperature gas and flame may be ejected to the outside through the connector opening 420H of the end plate 400 and the connector opening hole 620H of the insulating cover 600, which may damage the adjacent battery module or cause another thermal runaway phenomenon of the adjacent battery module. Ultimately, the thermal runaway phenomenon may propagate to a plurality of battery modules, which may cause explosion and ignition of the battery pack.

Therefore, the connector cover part 800 is provided in the battery module 100 according to the present embodiment, to thereby close the gap between the connector opening 420H and the connector opening hole 620H or the gap between the connector opening hole 620H and the module connector 510. Thereby, it is possible to suppress the high-temperature gas or flame from being ejected to the outside of the battery module 100. Ultimately, it is possible to prevent the thermal runaway phenomenon occurring in any one of the battery modules from propagating to other battery modules.

In summary, the battery module 100 according to the present embodiment may include at least one of the terminal cover part 700 and the connector cover part 800 and thus close the gap formed in the process of realizing HV connection or LV connection. Therefore, even if a high-temperature gas and flame are generated due to a thermal runaway phenomenon within the battery module 100, it is possible to suppress propagation to other battery modules by being ejected to the outside.

Although the terms representing directions such as front, rear, left, right, upper and lower directions are used herein, it would be obvious to those skilled in the art that these merely represent for convenience of explanation, and may differ depending on a position of an object, a position of an observer, or the like.

The above-mentioned battery pack according to the present embodiment may include not only a battery module but also various control and protection systems such as BMS (battery management system), BDU (battery disconnect unit), and a cooling system.

The battery module and battery pack can be applied to various devices. Specifically, such a device can be applied to a vehicle means such as an electric bicycle, an electric vehicle, or a hybrid vehicle, or ESS (energy storage system), but the present disclosure is not limited thereto, and is applicable to various devices that can use a secondary battery.

Although preferred embodiments of the present disclosure have been described in detail above, the scope of the present disclosure is not limited thereto, and various modifications and improvements made by those skilled in the art using the basic concepts of the present disclosure, which are defined in the appended claims, also belong to the scope of the present disclosure.

### DESCRIPTION OF REFERENCE NUMERALS

100: battery module
120: battery cell stack
200: module frame
300: busbar frame
320: terminal busbar
400: end plate
410H: terminal opening
420H: connector opening
510: module connector
700: terminal cover part
800: connector cover part

1. A battery module comprising:
a battery cell stack in which a plurality of battery cells are stacked;
a module frame that houses the battery cell stack;
end plates located on a first side and a second side of the battery cell stack, each end plate having a terminal opening and a connector opening;
a terminal busbar that is exposed through the terminal opening;
a module connector that is exposed through the connector opening; and
a cover, the cover being at least one of a terminal cover part that covers a portion where the terminal busbar is exposed, and a connector cover part that covers a portion where the module connector is exposed.

2. The battery module according to claim 1,
further comprising an external busbar joined to the terminal busbar,
wherein the cover is the terminal cover part, the terminal cover part covers a portion where the terminal busbar and the external busbar are joined.

3. The battery module according to claim 2, wherein:
the terminal cover part is formed with a terminal passing part through which the external busbar passes.

4. The battery module according to claim 1,
further comprising a connection member connected to the module connector,
wherein the cover is the connector cover part, the connector cover part covers a portion where the connection member and the module connector are connected.

5. The battery module according to claim 4, wherein:
the connector cover part is formed with a connector passing part through which the connection member passes.

6. The battery module according to claim 1,
further comprising a busbar frame located between the battery cell stack and the end plate.

7. The battery module according to claim 6, wherein:
the terminal busbar and the module connector are mounted on the busbar frame.

8. The battery module according to claim 6,
further comprising an insulating cover located between the busbar frame and the end plate.

9. The battery module according to claim 8, wherein:
the cover is the terminal cover part, and the terminal cover part is fastened to the end plate or the insulating cover through a hinge.

10. The battery module according to claim 8, wherein:
a terminal opening hole is formed in a portion of the insulating cover corresponding to the terminal opening.

11. The battery module according to claim 10, wherein:
the terminal cover part covers the terminal opening hole.

12. The battery module according to claim 8, wherein:
a connector opening hole is formed in a portion of the insulating cover corresponding to the connector opening.

13. The battery module according to claim 12, wherein:
the cover is the connector cover part, and the connector cover part covers the connector opening hole.

14. A battery pack comprising the battery module according to claim 1.
